(19) United States
(12) Patent Application Publication
(10) Pub. No.: US 2025/0075281 A1
(43) Pub. Date: Mar. 6, 2025

(54) BRAKE DISC AND MANUFACTURING METHOD THEREOF

(71) Applicants: HYUNDAI MOTOR COMPANY, Seoul (KR); KIA CORPORATION, Seoul (KR)

(72) Inventors: Young Jae Kim, Pohang-si (KR); Yoon Cheol Kim, Suwon-si (KR); Sang Mok Lee, Suwon-si (KR); Byoung Soo Yoo, Incheon (KR); Kwang Soo Lee, Hwaseong-si (KR); Kyung Jae Lee, Seongnam-si (KR)

(73) Assignees: HYUNDAI MOTOR COMPANY, Seoul (KR); KIA CORPORATION, Seoul (KR)

(21) Appl. No.: 18/583,426

(22) Filed: Feb. 21, 2024

(30) Foreign Application Priority Data
Sep. 6, 2023 (KR) 10-2023-0118106

(51) Int. Cl. C21D 9/00; C21D 1/30; C21D 1/74; C21D 1/84; C21D 5/00; C22C 37/08; C22C 37/10; C23C 8/26; C23C 8/80; F16D 65/12

(52) U.S. Cl. CPC C21D 9/0068; C21D 1/30; C21D 1/74; C21D 1/84; C21D 5/00; C22C 37/08; C22C 37/10; C23C 8/26; C23C 8/80; F16D 65/125; F16D 2200/0013; F16D 2250/0007; F16D 2250/0053

(57) ABSTRACT

A brake disc, and a method of manufacturing the same, yield a brake disc capable of exhibiting low thermal deformation and superior wear resistance and corrosion resistance using a new composition for grey cast iron and through nitriding gas treatment thereof.

### CROSS-REFERENCE TO RELATED APPLICATION

This application claims, under 35 U.S.C. § 119(a), the benefit of and priority to Korean Patent Application No. 10-2023-0118106, filed on Sep. 6, 2023, the entire contents of which are incorporated herein by reference.

### BACKGROUND

### (a) Technical Field

The present disclosure relates to a brake disc and a method of manufacturing the same, and more particularly to a brake disc capable of exhibiting low thermal deformation and superior wear resistance and corrosion resistance using a new composition for grey cast iron and through nitriding gas treatment thereof.

### (b) Background Art

A disc brake-type braking system for automobiles is a device for slowing and stopping, i.e., braking an automobile using frictional force by pressing opposite side of a brake disc with a brake pad operated by a hydraulic piston.

When selecting the material for the brake disc, which is the main part of the braking system, castability, thermal conductivity, vibration damping ability, wear resistance, and cost must be considered. In this regard, iron with greater than 1.7 weight percent (wt %) carbon is called cast iron. Grey cast iron is cast iron with a portion of carbon liberated and graphitized. Grey cast iron is commonly used because it has superior characteristics as a brake disc material as described above.

However, when grey cast iron, having low corrosion resistance, is not subjected to anti-rust treatment, red rust including Fe₂O₃(α) as the main component may occur on the surface thereof and may turn into high-density black rust (Fe₃O₄) over time.

Since red rust has a relatively low density compared to black rust and is easily scraped or peeled off by braking, the progression thereof to black rust may be delayed upon frequent braking. However, in the case in which vehicles are not driven for a long period of time or the frequency of use of brakes is low as in electric vehicles that are equipped with regenerative braking and decelerate using regenerative braking instead of brakes, red rust formed on the surface of the brake disc may be converted into black rust before removal by friction with the brake pad.

In this way, when red rust and black rust accumulate unevenly on the surface of a brake disc, braking characteristics may deteriorate and noise and judder may occur. Thus, separate anti-rust treatment is required.

Generally, a nitriding treatment is performed on the surface of a brake disc. Pearlite and graphite, which make up the matrix structure of grey cast iron, have a problem of inhibiting diffusion of nitrogen. Thus, the depth of the nitride layer formed by nitriding treatment is low and the thickness thereof is uneven, so limitations are imposed on quality improvement.

In addition, when nitrogen potential (KN), heat treatment temperature, and time are increased to thicken the nitride layer, thermal deformation of the brake disc may increase, which causes noise and judder to worsen.

### SUMMARY

The present disclosure has been made keeping in mind the problems encountered in the related art. The present disclosure is intended to provide a brake disc with improved corrosion resistance and wear resistance by forming a thick and uniform layer including nitride on a disc body made of grey cast iron, and to provide a method of manufacturing the same.

In particular, the present disclosure is intended to provide a brake disc with improved corrosion resistance and wear resistance by introducing a new composition of grey cast iron that is advantageous for forming the layer including nitride, and to provide a method of manufacturing the same.

The objects of the present disclosure are not limited to the foregoing. The objects of the present disclosure should be more clearly understood through the following description and may be realized by the means described in the claims and combinations thereof.

An aspect of the present disclosure provides a method of manufacturing a brake disc. The brake disc includes a casting step of a disc body including grey cast iron, a post-processing step of the processing the surface of the disc body, and a nitriding treatment step of forming a nitride layer by subjecting the disc body. The surface of the disc body is processed, with a nitriding gas, in which the grey cast iron includes 2.4-3.8 wt % of carbon (C), 0.5-0.8 wt % of silicon (Si), 0.5-0.8 wt % of manganese (Mn), and at least one additional material selected from nickel (Ni), copper (Cu), chromium (Cr), tin (Sn), titanium (Ti), vanadium (V), or any combination thereof.

In an embodiment, the grey cast iron may include 0.01-0.1 wt % of nickel (Ni).

In an embodiment, the grey cast iron may include 0.3-0.8 wt % of copper (Cu).

In an embodiment, the grey cast iron may include 0.03-0.12 wt % of tin (Sn).

In an embodiment, the nitriding treatment step may be performed at a temperature of 550-600° C. for 4-5 hours.

In an embodiment, the nitriding gas may include at least one gas selected from ammonia (NH₃), nitrogen (N₂), or any combination thereof.

In an embodiment, the average thickness of the nitride layer may be 10 micrometers (μm) or more. In one example, the average thickness of the nitride layer is 20 μm or more.

In an embodiment, the nitride layer may include at least one material selected from ε-Fe₂₋₃N, γ-Fe₄N, or any combination thereof.

In an embodiment, the nitrogen potential (Kn) of the nitriding gas may be 5-10.

In an embodiment, during the nitriding treatment step, the disc body may be treated with the nitriding gas so that a diffusion layer is formed between the disc body and the nitride layer.

In an embodiment, the thickness of the diffusion layer may be 30-150 μm.

In an embodiment, the method may further include a stress relief step by heat treating the disc body at a temperature of 600° C. or higher in a reducing atmosphere after the casting step.

In an embodiment, the method may further include a cooling step of the disc body having the nitride layer through furnace cooling after the nitriding treatment step. A temperature for furnace cooling of the disc body may be 50-150° C.

Here, the cooling step may include air cooling after the furnace cooling.

In an embodiment, the method may not include a separate oxynitriding heat treatment process for forming an oxide layer including iron oxide on the nitride layer after the nitriding treatment step.

### BRIEF DESCRIPTION OF THE DRAWINGS

The above and other features of the present disclosure are described in detail referring to certain exemplary embodiments thereof illustrated in the accompanying drawings, which are given hereinbelow by way of illustration only, and thus are not limitative of the present disclosure, and wherein:

FIG. 1 schematically shows the structure of a brake disc manufactured according to the present disclosure;

FIG. 2 shows a cross-section of the surface layer of the brake disc manufactured according to an embodiment of the present disclosure;

FIG. 3 shows a scanning electron microscope (SEM) image that the cross-section of the surface layer of the brake disc manufactured according to an embodiment of the present disclosure;

FIG. 4 shows results of electron backscattered diffraction (EBSD) analysis of the cross-section of the surface layer of the brake disc manufactured according to an embodiment of the present disclosure;

FIGS. 5 and 6 show results of energy dispersive spectroscopy (EDS) of the cross-section of the surface layer of the brake disc manufactured according to an embodiment of the present disclosure;

FIGS. 7-9 show images that the cross-section of the surface layer of the brake disc manufactured according to an embodiment of the present disclosure;

FIG. 10 shows a graph that the thickness of the nitride layer varying depending on nitriding potential (Kn); and

FIG. 11 shows results of simulation of thicknesses of the nitride layer and the diffusion layer varying depending on the amount of carbon (C) in grey cast iron.

### DETAILED DESCRIPTION

The above and other objects, features, and advantages of the present disclosure should be more clearly understood from the following embodiments taken in conjunction with the accompanying drawings. However, the present disclosure is not limited to the embodiments disclosed herein and the embodiments may be modified into different forms. These embodiments are provided to thoroughly explain the disclosure and to sufficiently convey the spirit of the present disclosure to those of ordinary skill in the art.

Throughout the drawings, the same reference numerals refer to the same or like elements. For the sake of clarity of the present disclosure, the dimensions of structures are depicted as being larger than the actual sizes thereof. It should be understood that, although terms such as “first”, “second”, and the like, may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It should be further understood that the terms “comprise”, “include”, “have”, and the like, and variations thereof, when used in this specification, specify the presence of stated features, integers, steps, operations, elements, components, or combinations thereof. Such terms do not preclude the presence or addition of one or more other features, integers, steps, operations, elements, components, or combinations thereof. Also, it should be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others. Thus, such numbers, values, representations, and the like should be understood to be modified by the term “about” in all cases. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. Still further when a component, device, element, or the like of the present disclosure is described as having a purpose or performing an operation, function, or the like, the component, device, or element should be considered herein as being “configured to” meet that purpose or to perform that operation or function.

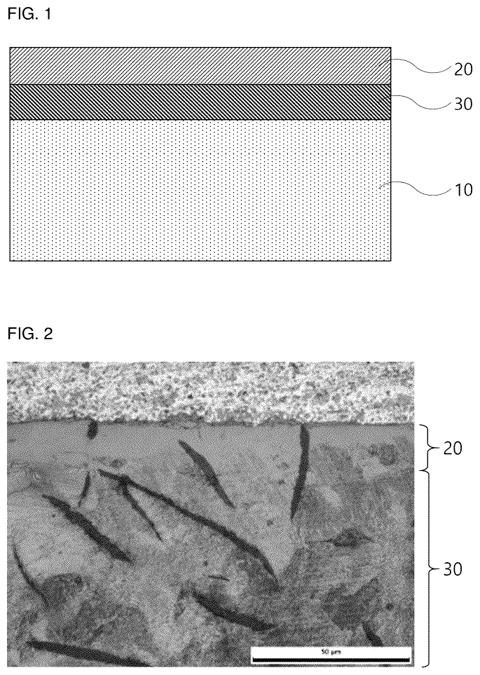

FIG. 1 schematically shows the structure of a brake disc manufactured according to the present disclosure. A method of manufacturing a brake disc according to an aspect of the present disclosure may include a casting step of casting a disc body 10 including grey cast iron. The method may also include a post-processing step of processing or post-processing the surface of the disc body 10. The method may also include a nitriding treatment step of forming a nitride layer 20 by subjecting the disc body, the surface of which has been processed, with a nitriding gas.

During the casting step, the grey cast iron means that a portion of carbon in cast iron with greater than 1.7 weight percent (wt %) carbon based on 100 wt % of the disc body is liberated and graphitized, and may generally include carbon (C), silicon (Si), manganese (Mn), phosphorus (P), and sulfur (S).

In an embodiment, the grey cast iron may include 2.4-3.8 wt % of carbon (C); 1.5-2.5 wt % of silicon (Si); 0.5-0.8 wt % of manganese (Mn); and at least one material selected from the group including or consisting of nickel (Ni), copper (Cu), chromium (Cr), tin (Sn), titanium (Ti), vanadium (V), or any combination thereof.

As the grey cast iron according to the present disclosure includes 2.4-3.8 wt % of carbon (C), diffusion of nitrogen into the disc body may increase, making it possible to more easily increase the thickness of the nitride layer. If the amount of carbon (C) is less than 2.4 wt %, the heat dissipation characteristics of the brake disc may deteriorate. On the other hand, if the amount of carbon (C) exceeds 3.8 wt %, formation of the nitride layer may be inhibited.

As the grey cast iron includes 1.5-2.5 wt % of silicon (Si), diffusion of nitrogen into the disc body may increase, making it possible to more easily increase the thickness of the nitride layer. If the amount of silicon (Si) is less than 1.5 wt %, heat dissipation characteristics of the brake disc may deteriorate. On the other hand, if the amount of silicon (Si) exceeds 2.5 wt %, formation of the nitride layer may be inhibited.

As the grey cast iron includes 0.5-0.8 wt % of manganese (Mn), formation of Pyrrhotite or iron sulfide (FeS) may be suppressed and hot cracking of the brake disc may be prevented. If the amount of manganese (Mn) is less than 0.5 wt %, the extent of formation of the FeS phase may increase, whereas if the amount thereof exceeds 0.8 wt %, machinability may deteriorate.

In an embodiment, the grey cast iron may include 0.01-0.1 wt % of nickel (Ni). As the grey cast iron includes 0.01-0.1 wt % of nickel (Ni), the grey cast iron may be solid-solution strengthened and wear resistance of the brake disc may be increased. If the amount of nickel (Ni) is less than 0.01 wt %, hardness and strength of the brake disc may decrease. On the other hand, if the amount of nickel (Ni) exceeds 0.1 wt %, machinability may deteriorate.

In an embodiment, the grey cast iron may include 0.3-0.8 wt % of copper (Cu). As the grey cast iron includes 0.3-0.8 wt % of copper, the grey cast iron may be solid-solution strengthened and the wear resistance of the brake disc may be increased. If the amount of copper (Cu) is less than 0.3 wt %, the hardness and strength of the brake disc may decrease. On the other hand, if the amount of copper (Cu) exceeds 0.8 wt %, machinability may deteriorate.

In an embodiment, the grey cast iron may include 0.03-0.12 wt % of tin (Sn). As the grey cast iron includes 0.03-0.12 wt % of tin (Sn), the grey cast iron may be solid-solution strengthened and wear resistance of the brake disc may be increased. If the amount of tin (Sn) is less than 0.03 wt %, hardness and strength of the brake disc may decrease. On the other hand, if the amount of tin (Sn) exceeds 0.12 wt %, heat generation characteristics may be reduced.

In an embodiment, the grey cast iron may include 0.1-0.5 wt % of chromium (Cr). As the grey cast iron includes 0.1-0.5 wt % of chromium (Cr), it may serve as a carbide former and a theta-phase stabilizer. If the amount of chromium (Cr) is less than 0.1 wt %, the hardness of the brake disc may decrease. On the other hand, if the amount of chromium (Cr) exceeds 0.5 wt %, the formation of the nitride layer may be inhibited.

In an embodiment, the grey cast iron may include 0.01-0.05 wt % of titanium (Ti). As the grey cast iron includes 0.01 0.05 wt % of titanium (Ti), the wear resistance of the brake disc may be increased. If the amount of titanium (Ti) is less than 0.01 wt %, the increase in wear resistance may be insignificant. On the other hand, if the amount of titanium (Ti) exceeds 0.05 wt %, heat dissipation characteristics may be reduced.

In an embodiment, the grey cast iron may include 0.01-0.05 wt % of vanadium (V). As the grey cast iron includes 0.01-0.05 wt % of vanadium (V), the wear resistance of the brake disc may be increased. If the amount of vanadium (V) is less than 0.01 wt %, the increase in wear resistance may be insignificant. On the other hand, if the amount of vanadium (V) exceeds 0.05 wt %, heat dissipation characteristics may be reduced.

Here, casting in the casting step may be applied without particular limitation as to the shape, size, and casting process of the disc body, so long as they are generally used in manufacturing brake discs.

The post-processing step (machine casting) is a step of trimming the surface of the cast disc body. The post-processing may include rough machining that processes the surface of the disc body to within a certain dimensional margin and then fine machining that precisely processes the surface of the disc body to a specified size.

The nitriding treatment step is a step of forming a nitride layer at the surface by performing nitriding on the disc body, the surface of which is processed through the post-processing step. The nitride layer thus formed has higher hardness than grey cast iron and is capable of improving corrosion resistance and wear resistance of the brake disc.

Specifically, the nitriding gas may be injected into a furnace in which the post-processed disc body is placed.

The nitriding gas may include at least one selected from the group including or consisting of ammonia (NH₃), nitrogen (N₂), or any combination thereof. Here, a reducing gas or an inert gas may be injected together with the nitriding gas to create a reducing atmosphere in the furnace. Examples of the reducing gas may include RX Gas®, CO, H₂, and the like. The inert gas may be a gas including at least one selected from the group including or consisting of N₂, Group 17 elements, or any combination thereof. As such, nitriding treatment is performed in a reducing atmosphere, thereby preventing the unintentional generation of iron oxide on the surface of the disc body during the nitriding treatment step.

Thereafter, the temperature of the furnace may be raised to a temperature in a range of 550-600° C., and the nitriding treatment may be performed on the surface of the disc body for 4-5 hours. Here, the temperature may be gradually raised over 60-120 minutes.

If the nitriding treatment temperature is lower than 550° C., diffusion of nitrogen may be suppressed and the thickness of the nitride layer may be reduced. On the other hand, if the nitriding treatment temperature exceeds 600° C., thermal deformation of the disc body may become severe.

If the nitriding treatment time is less than 4 hours, the thickness of the nitride layer may decrease due to lack of time for a sufficient amount of nitride layer to be formed. On the other hand, if the nitriding treatment time exceeds 5 hours, thermal deformation of the disc body may become severe.

The average thickness of the nitride layer formed through the nitriding treatment step may be 10 micrometers (μm) or more, and in one example may be 20 μm or more. When the average thickness of the nitride layer is 10 μm or more, corrosion resistance and wear resistance of the brake disc may be improved. In particular, when the average thickness of the nitride layer is 20 μm or more, corrosion resistance and wear resistance of the brake disc may be further improved.

In an embodiment, the nitrogen potential (Kn) of the nitriding gas may be 5-10. The nitriding gas, for example, ammonia (NH₃), injected into the furnace during the nitriding treatment step, may be decomposed through the following process.

2NH₃→N₂+3H₂

As such, the nitrogen potential (Kn) may be defined as a ratio of partial pressure of NH₃ (P_{NH3}) to partial pressure of H₂ (P_{H2}) in a reducing atmosphere (Kn=P_{NH3}/(P_{H2})^{3/2}).

When nitrogen potential (Kn) in the furnace is 5-10, a nitride layer having an appropriate thickness desired by the present disclosure may be formed. If the nitrogen potential (Kn) is less than 5, the thickness of the nitride layer may be less than 10 μm.

On the other hand, if the nitrogen potential (Kn) exceeds 10, thermal deformation of the brake disc may become severe.

In an embodiment, the nitride layer may include at least one material selected from the group including or consisting of ε-Fe₂₋₃N, γ-Fe₄N, or any combination thereof.

During the nitriding treatment step, the grey cast iron and nitrogen may react to produce ε-Fe₂N, ε-Fe₃N, and γ-Fe₄N. Since ε-Fe₂₋₃N and γ-Fe₄N have higher hardness than general grey cast iron and are not easily oxidized, the nitride layer including ε-Fe₂₋₃N or γ-Fe₄N has superior wear resistance and high corrosion resistance. In addition, the nitride layer including ε-Fe₂₋₃N or γ-Fe₄N may have a frictional coefficient reduced by 4-10% compared to a disc body without the nitride layer.

Also, in the relative ratio of ε-Fe₂₋₃N and γ-Fe₄N included in the nitride layer, ε-Fe₂₋₃N may be 80% or more.

In an embodiment, during the nitriding treatment step, the disc body may be treated with nitriding gas so that a diffusion layer 30 is formed between the disc body 10 and the nitride layer 20.

The diffusion layer is formed inside the disc body, is similar to a carburizing layer, and serves to increase the surface hardness of the disc body and to impart toughness to the inside, thereby improving fatigue resistance, high-temperature strength, and corrosion resistance.

In an embodiment, the thickness of the diffusion layer may be 30-150 μm. If the thickness of the diffusion layer is less than 30 μm, it may be difficult to fully improve fatigue resistance, high-temperature strength, and corrosion resistance of the disc body.

In an embodiment, a stress relief step by heat treating the disc body at a temperature of 600° C. or higher in a reducing atmosphere after the casting step may be further included. The stress relief step is a step of removing residual stress remaining inside the disc body during casting of the disc body. The stress relief step may be performed by injecting a reducing gas or an inert gas into a furnace in which the disc body is placed to form a reducing atmosphere in the furnace and then conducting heat treatment for about 5 hours at a temperature of 600° C. or higher.

In an embodiment, the cooling step of the disc body having the nitride layer through furnace cooling after the nitriding treatment step may be further included. The furnace cooling temperature may be 50-150° C. By cooling the disc body having the nitride layer within the furnace cooling temperature range, thermal deformation of the manufactured brake disc may be prevented and numerical accuracy may be improved. Here, thermal deformation or numerical accuracy of the brake disc may be represented by run out (R/O), which indicates thickness uniformity in the circumferential direction of one side of the disc, or disc thickness variation (DTV), which is a value representing thickness variation in the circumferential direction, as a difference between R/O values on both sides of the disc.

In an embodiment, R/O of the brake disc manufactured according to the present disclosure may be 5.0 or less but greater than 4.0. Also, DTV of the brake disc manufactured according to the present disclosure may be 2.0-2.25.

In an embodiment, the cooling step may include an air cooling after the furnace cooling.

As the disc body having the nitride layer is subjected to the furnace cooling and the air cooling, the nitride layer may react with oxygen in the air, thereby forming an oxide layer on the nitride layer. Here, the oxide layer may include iron(II, III) oxide (Fe₃O₄). Since Fe₃O₄ is no longer oxidized, the oxide layer formed on the nitride layer may further improve corrosion resistance of the brake disc.

In an embodiment, after the nitriding treatment step, a separate oxynitriding heat treatment process for forming an oxide layer including iron oxide on the nitride layer may not be performed. The oxynitriding heat treatment process performed to form the oxide layer on the nitride layer enables a plurality of pores to be formed in the oxide layer. The manufacturing method according to the present disclosure does not include a separate oxynitriding heat treatment process for forming the oxide layer after nitriding treatment, thereby reducing process costs and minimizing thermal deformation of the brake disc.

A better understanding of the present disclosure may be obtained through the following examples and comparative examples. However, these examples are not intended to limit the scope of the present disclosure.

### Manufacture of a Brake Disc

### 1. Casting of a Disc Body

A disc body was cast using grey cast iron including carbon in the amount shown in Table 1 below. The composition other than carbon was as follows: Si: 1.5-2.5 wt %, Mn: 0.5-0.8 wt %, Ni: 0.01-0.1 wt %, Cu: 0.3-0.8 wt %, Cr: 0.1-0.5 wt %, Sn: 0.03-0.12 wt %, Ti: 0.01-0.05 wt %, V: 0.01-0.05 wt %, and Fe: balance. Also, phosphorus (P) and sulfur (S) in the composition of grey cast iron were included in amounts generally necessary for casting grey cast iron constituting a brake disc.

TABLE 1

| Classification | Carbon (C) (wt %) |
|---|---|
| Preparation Example 1 | 3.75 |
| Preparation Example 2 | 3.65 |
| Preparation Example 3 | 3.40 |
| Comparative Preparation Example 1 | 0.3 |

### 2. Post-Processing Step and Nitriding Treatment Step

The surface of the disc body prepared as above was processed through rough machining and fine machining.

Then, the surface-processed disc body was placed in a furnace, after which ammonia gas (NH₃) and RX Gas® were injected at 14 m³/hr and 1 m³/hr, respectively.

After the temperature of the furnace was set to 580° C., nitriding treatment was performed for 240 minutes.

### 3. Cooling Step

After the temperature of the furnace was set to 150° C., the disc body was gradually cooled. Then, the disc body was taken out of the furnace and air-cooled at room temperature for a sufficient period of time, ultimately manufacturing a brake disc.

### Example 1

A brake disc was manufactured through the above-described process using grey cast iron according to Preparation Example 1.

### Example 2

A brake disc was manufactured through the above-described process using grey cast iron according to Preparation Example 2.

### Example 3

A brake disc was manufactured through the above-described process using grey cast iron according to Preparation Example 3.

### Example 4

A brake disc was manufactured in the same manner as in Example 1, with the exception that nitriding treatment was performed for 20 hours under the condition that the nitriding potential (Kn) was set to 10.

### Example 5

A brake disc was manufactured in the same manner as in Example 1, with the exception that nitriding treatment was performed for 20 hours under the condition that the nitriding potential (Kn) was set to 5.

### Comparative Example 1

A brake disc was manufactured through the above-described process using grey cast iron according to Comparative Preparation Example 1.

### Comparative Example 2

A brake disc was manufactured through the above-described process using iron not including carbon and silicon as the material for a disc body.

### Comparative Example 3

A brake disc was manufactured in the same manner as in Example 1, with the exception that cooling was gradually performed under the condition that the temperature of the furnace was set to 250° C.

### Comparative Example 4

A brake disc was manufactured in the same manner as in Example 1, with the exception that nitriding treatment was performed under the condition that ammonia gas (NH₃) and RX Gas® were injected into the furnace at 7 m³/hr and 1 m³/hr, respectively.

### Comparative Example 5

A brake disc was manufactured in the same manner as in Example 1, with the exception that nitriding treatment was performed for 20 hours under the condition that the nitriding potential (Kn) was set to 2.

### Comparative Example 6

A brake disc was manufactured in the same manner as in Example 1, with the exception that nitriding treatment was performed for 20 hours under the condition that the nitriding potential (Kn) was set to 1.

### Test Example 1—Analysis of a Surface of a Brake Disc

In order to analyze the surface of the brake disc manufactured according to the present disclosure, a cross-section of the surface layer of the bake disc according to Example 1 was taken and is shown in FIG. 2.

As shown in FIG. 2, the nitride layer formed on the diffusion layer was confirmed. The thickness of the diffusion layer was about 60 μm, and the thickness of the nitride layer was about 15 μm.

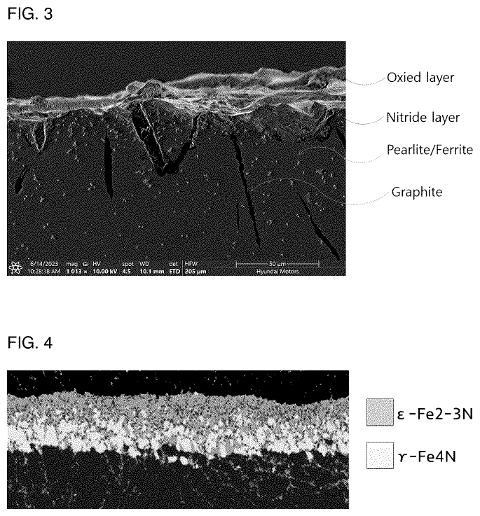

In addition, in order to confirm the composition of the nitride layer and the diffusion layer formed at the surface of the brake disc according to Example 1, the cross-section of the surface layer of the brake disc was taken with a scanning electron microscope (SEM) and is shown in FIG. 3.

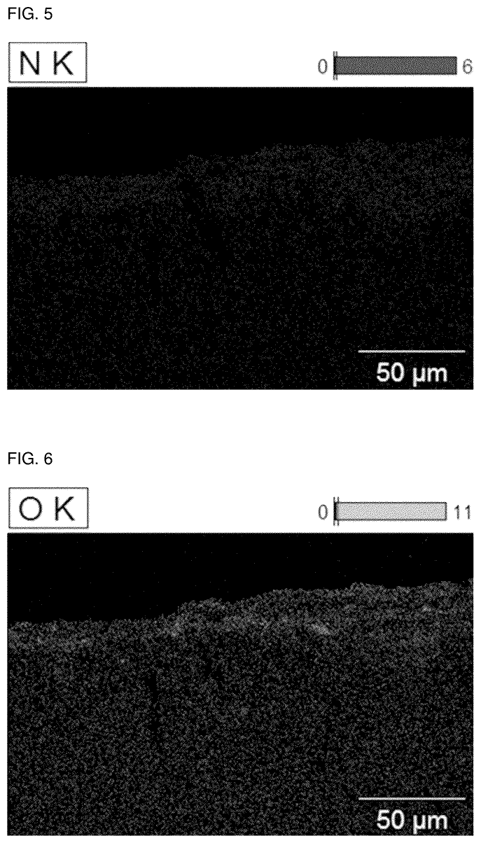

The cross-section of the surface layer of the brake disc according to Example 1 was analyzed with EDS/EBSD and the results thereof are shown in FIG. 4. Also, in order to confirm the distribution of nitrogen and oxygen contained in the surface layer of the brake disc, EDS was performed and the results thereof are shown in FIGS. 5 and 6 respectively.

Referring to FIGS. 3, 5, and 6, it was confirmed that nitrogen was distributed throughout the diffusion layer and the nitride layer but was mainly distributed in the surface of the brake disc. In addition, oxygen was distributed throughout the diffusion layer and the nitride layer but was mainly distributed in the outermost surface of the brake disc, indicating formation of an oxide layer including Fe₃O₄.

Referring to FIG. 4, it was confirmed that ε-Fe₂₋₃N and γ-Fe₄N were uniformly distributed within the nitride layer.

### Test Example 2—Analysis of the Thickness of the Nitride Layer Depending on the Composition of Grey Cast Iron

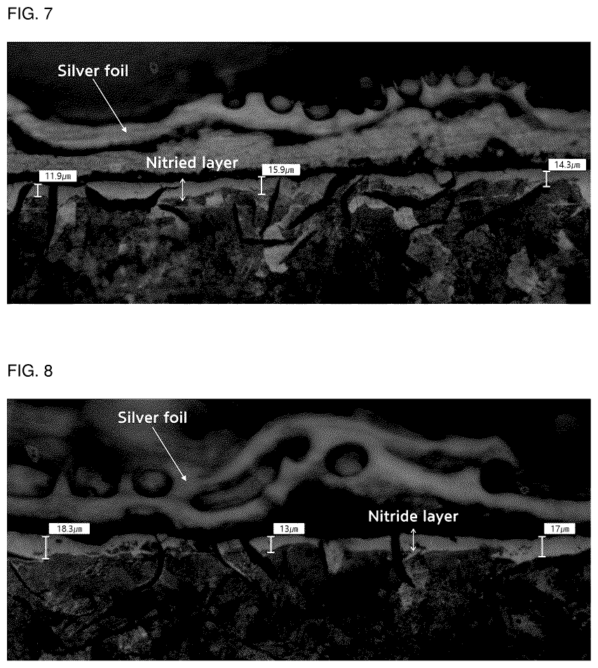

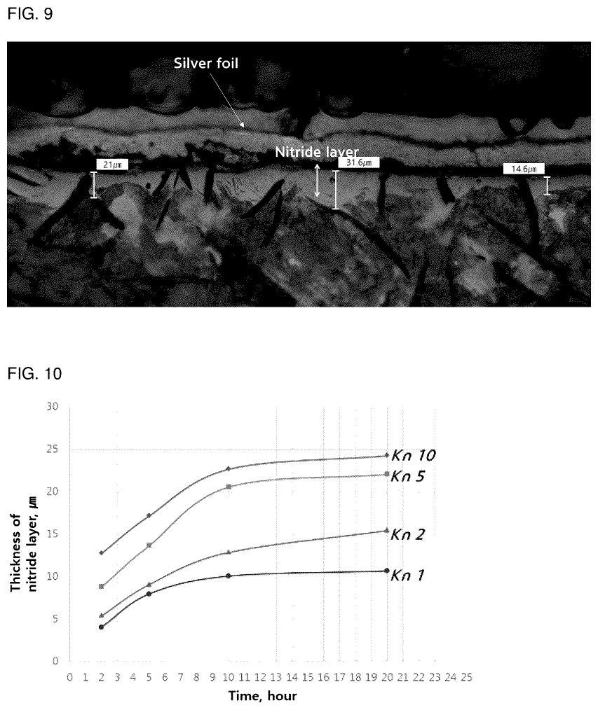

In order to determine the thickness of the nitride layer depending on the amount of carbon in grey cast iron, the thickness of the nitride layer of the brake disc according to each of Examples 1-3 was measured at different measurement positions. The results thereof are shown in FIGS. 7-9 and Table 2 below.

TABLE 2

| Unit (μm) | Example 1 | Example 2 | Example 3 |
|---|---|---|---|
| 1 | 11.9 | 18.3 | 21 |
| 2 | 15.9 | 13 | 31.6 |
| 3 | 14.3 | 17 | 14.6 |
| 4 | 13.2 | 15.9 | 13.2 |
| 5 | 10.5 | 18.3 | 21 |
| 6 | 13.2 | 22.4 | 14.3 |
| 7 | 11.9 | 21 | 13.2 |
| 8 | 18.3 | 23.7 | 11.9 |
| 9 | 9.2 | 15.9 | 34.3 |
| 10 | 17.3 | 10.5 | 28.9 |
| 11 | 15.7 | 19.7 | 22.4 |
| 12 | 18.6 | 15.7 | 18.3 |
| Average | 14.16667 | 17.61667 | 20.39167 |
| Standard deviation | 3.0479 | 3.79613 | 7.66817 |

Referring to Table 2, it was confirmed that the lower the amount of carbon in grey cast iron, the thicker the nitride layer.

### Test Example 3—Analysis of the Thickness of the Nitride Layer Depending on Nitriding Potential

In order to determine the effect of the nitriding potential (Kn) on the thickness of the nitride layer formed on the disc body during nitriding treatment, the thickness of the nitride layer of each of Examples 4 and 5 and Comparative Examples 5 and 6 was measured. The thickness of the nitride layer was measured every hour. The results thereof are shown in FIG. 10.

Referring to FIG. 10, the thickness of the nitride layer was confirmed to increase with an increase in the nitriding potential (Kn) during nitriding treatment.

### Test Example 4—Computational Analysis of the Thickness of the Nitride Layer and the Diffusion Layer

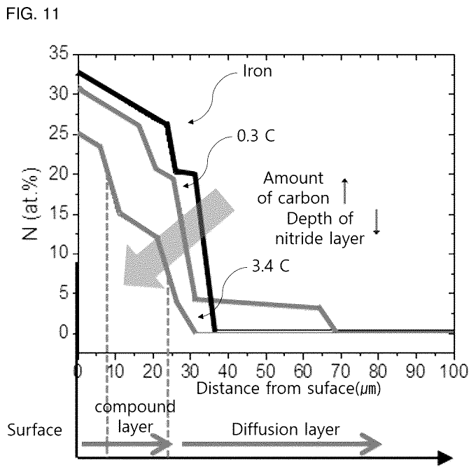

In order to simulate the thicknesses of the nitride layer and the diffusion layer varying depending on the amount of carbon in grey cast iron, DICTRA software commercially available from Thermo-Calc Software, Inc., McMurray, Pennsylvania was used. The thicknesses of the nitride layer and the diffusion layer for grey cast iron including carbon in the amount according to Preparation Example 3, grey cast iron including carbon in the amount according to Comparative Preparation Example 1, and iron were simulated, and the results thereof are shown in FIG. 11.

Referring to FIG. 11, it was confirmed that the lower the amount of carbon in grey cast iron (or iron), the thicker the nitride layer and the diffusion layer.

### Test Example 5—Measurement of the Thermal Deformation Depending on the Furnace Cooling Temperature and the Nitriding Gas Injection Rate

In order to determine the effects of the nitriding gas injection rate during nitriding treatment step and the furnace cooling temperature during cooling step after nitriding treatment step on thermal deformation of the brake disc, R/O and DTV of Example 1, Comparative Example 3, and Comparative Example 4 were measured.

The results thereof are shown in Table 3 below.

TABLE 3

| | | | Comparative | Comparative |
|---|---|---|---|---|
| | | Example 1 | Example 3 | Example 4 |
| R/O | Average | 4.2 | 4.0 | 5.2 |
| | Deviation | 3.2 | 4.5 | 3.8 |
| DTV | Average | 2.03 | 2.25 | 2.92 |
| | Deviation | 1.3 | 0.97 | 1.36 |

Referring to Table 3, the brake disc according to Example 1 was excellent in both R/O and DTV modes in a balanced manner.

As should be apparent from the above description, according to the present disclosure, a disc body is treated with a nitriding gas to form a nitride layer, thereby enabling formation of a thick and uniform nitride layer compared to when using a conventional salt bath nitriding method.

In addition, grey cast iron according to the present disclosure includes 2.4-3.8 wt % of carbon (C), 0.5-0.8 wt % of silicon (Si), 0.5-0.8 wt % of manganese (Mn), and at least one material selected from the group including or consisting of nickel (Ni), copper (Cu), chromium (Cr), tin (Sn), titanium (Ti), vanadium (V), or any combination thereof, thereby more easily achieving a desired thickness of the nitride layer.

The effects of the present disclosure are not limited to the above-mentioned effects. It should be understood that the effects of the present disclosure include all effects that can be inferred from the description of the present disclosure.

As the test examples and examples of the present disclosure have been described in detail above, the scope of the present disclosure is not limited to the above-described test examples and examples. Various modifications and improvements made by those of ordinary skill in the art using the basic concept of the present disclosure defined in the following claims are also within the scope of the present disclosure.

What is claimed is:

1. A method of manufacturing a brake disc, the method comprising:
a casting step of a disc body comprising grey cast iron;
a post-processing step of processing a surface of the disc body; and
a nitriding treatment step of forming a nitride layer by subjecting the disc body, the surface of which is processed, with a nitriding gas,
wherein the grey cast iron comprises:
2.4-3.8 weight percent (wt %) of carbon (C),
0.5-0.8 wt % of silicon (Si),
0.5-0.8 wt % of manganese (Mn), and
one material selected from the group consisting of nickel (Ni), copper (Cu), chromium (Cr), tin (Sn), titanium (Ti), vanadium (V), and combinations thereof.

2. The method of claim 1, wherein the grey cast iron comprises 0.01-0.1 wt % of nickel (Ni).

3. The method of claim 1, wherein the grey cast iron comprises 0.3-0.8 wt % of copper (Cu).

4. The method of claim 1, wherein the grey cast iron comprises 0.03-0.12 wt % of tin (Sn).

5. The method of claim 1, wherein the nitriding treatment step is performed at a temperature in a range of 550-600° C. for 4-5 hours.

6. The method of claim 1, wherein the nitriding gas comprises one gas selected from the group consisting of ammonia (NH₃), nitrogen (N₂), and combinations thereof.

7. The method of claim 1, wherein an average thickness of the nitride layer is 10 micrometers (μm) or more.

8. The method of claim 1, wherein an average thickness of the nitride layer is 20 μm or more.

9. The method of claim 1, wherein the nitride layer comprises one material selected from the group consisting of ε-Fe₂₋₃N, γ-Fe₄N, and combinations thereof.

10. The method of claim 1, wherein a nitrogen potential (Kn) of the nitriding gas is 5-10.

11. The method of claim 1, wherein, during the nitriding treatment step, the disc body is treated with the nitriding gas so that a diffusion layer is formed between the disc body and the nitride layer.

12. The method of claim 11, wherein a thickness of the diffusion layer is 30-150 μm.

13. The method of claim 1, further comprising a stress relief step by heat treating the disc body at a temperature of 600° C. or higher in a reducing atmosphere after the casting step.

14. The method of claim 1, further comprising a cooling step of the disc body having the nitride layer through furnace cooling after the nitriding treatment step, wherein a temperature for the furnace cooling of the disc body is 50-150° C.

15. The method of claim 14, wherein the cooling step comprises an air cooling after the furnace cooling.

16. The method of claim 1, wherein a separate oxynitriding heat treatment process is not performed for forming an oxide layer comprising iron oxide on the nitride layer after the nitriding treatment step.
